(19) United States
(12) Patent Application Publication
(10) Pub. No.: US 2014/0156214 A1
(43) Pub. Date: Jun. 5, 2014

(54) MOTION ANALYSIS SYSTEM AND MOTION ANALYSIS METHOD

(71) Applicant: Seiko Epson Corporation, Tokyo (JP)

(72) Inventor: Kazuo Nomura, Shiojiri (JP)

(73) Assignee: Seiko Epson Corporation, Tokyo (JP)

(21) Appl. No.: 14/091,448

(22) Filed: Nov. 27, 2013

(30) Foreign Application Priority Data
Dec. 5, 2012 (JP) 2012-266039

(51) Int. Cl. G01B 21/16; G01P 15/00; G01P 3/00

(52) U.S. Cl. CPC G01B 21/16; G01P 3/00; G01P 15/00
USPC 702/141; 702/150; 702/151; 702/145

(57) ABSTRACT

A motion analysis system includes a signal comparing unit configured to compare output signals from a plurality of motion sensors attached to a measurement target and an attachment-position determining unit configured to determine attachment positions of the motion sensors to the measurement target on the basis of a comparison result of the signal comparing unit.

### BACKGROUND

1. Technical Field

The present invention relates to a motion analysis system and a motion analysis method.

2. Related Art

There is proposed a system for attaching a plurality of sensors to a person or an object and analyzing a motion state of the person or the object on the basis of detection results of the sensors. For example, JP-A-2009-125507 (Patent Literature 1) attains improvement of a golf swing by detecting motions of a person during the golf swing. Specifically, in Patent Literature 1, in order to detect movement of the person, acceleration sensors and gyro sensors are attached to the ear, arm, waist, and the like of the person to detect movements of the respective regions.

However, when a plurality of sensors for detecting movements are attached to regions of a person or an object as described in Patent Literature 1, it is necessary to associate the plurality of sensors with the regions to which the sensors are attached. Therefore, it takes labor and time for registration work necessary for associating the sensors and the regions. When the sensors and the regions are associated wrong, it is difficult to accurately detect movements of the person or the object.

### SUMMARY

An advantage of some aspects of the invention is to solve at least a part of the problems described above, and the invention can be implemented as the following forms and application examples.

### APPLICATION EXAMPLE 1

This application example is directed to a motion analysis system including: a signal comparing unit configured to compare output signals from a plurality of motion sensors attached to a measurement target; and an attachment-position determining unit configured to determine attachment positions of the motion sensors to the measurement target using a comparison result of the signal comparing unit.

In the motion analysis system, the signal comparing unit compares the respective output signals of the plurality of motion sensors attached to the measurement target. The attachment-position determining unit determines attachment positions of the motion sensors on the basis of an analysis result of the signal comparing unit. Since attachment positions of the motion sensors are determined on the basis of the output signals of the motion sensors, it is possible to automatically determine attachment positions of the motion sensors.

Consequently, labor and time for registration work concerning attachment positions of the motion sensors are unnecessary. Further, it is possible to prevent a trouble such as wrong registration of attachment positions of the motion sensors and accurately detect motions of regions of a person or an object.

### APPLICATION EXAMPLE 2

This application example is directed to the motion analysis system described above, wherein the signal comparing unit compares at least one of maximums or minimums concerning at least one of angular velocities and angles represented by the respective output signals of the plurality of motion sensors.

The motion analysis system determines attachment positions of the motion sensors on the basis of a comparison result of the maximums or the minimums of the angular velocities or the angles represented by the output signals of the motion sensors. The angular velocities or the angles of regions, to which the motion sensors are attached, variously change according to motions. Therefore, it is possible to associate the motion sensors and the regions by relatively comparing the maximums or the minimums of the angular velocities or the angles represented by the output signals of the motion sensors.

### APPLICATION EXAMPLE 3

This application example is directed to the motion analysis system described above, wherein the signal comparing unit compares at least one of maximums or minimums concerning accelerations represented by the respective output signals of the plurality of motion sensors.

The motion analysis system determines attachment positions of the motion sensors on the basis of a comparison result of maximums or minimums concerning accelerations represented by the output signals of the motion sensor. Accelerations of regions, to which the motion sensors are attached, variously change according to motions. Therefore, it is possible to associate the motion sensors and the regions by relatively comparing the maximums or the minimums of the accelerations represented by the output signals of the motion sensors.

### APPLICATION EXAMPLE 4

This application example is directed to the motion analysis system described above, the motion analysis system includes position determination information used for determining attachment positions of the motion sensors, the position determination information includes information concerning specified ranks respectively specified concerning the plurality of motion sensors and attachment positions corresponding to the specified ranks, and the attachment-position determining unit determines attachment positions by collating respective comparative ranks of the plurality of motion sensors and the specified ranks included in the position determination information using a comparison result of the signal comparing unit.

In the motion analysis system, the attachment-position determining unit collates comparative ranks of the motion sensors based on a comparison result of the signal comparing unit and the specified ranks of the position determination information and determines that attachment positions of the position determination information corresponding to the specified ranks are attachment positions of the motion sensors. Consequently, it is possible to easily automatically determine attachment positions of the motion sensors by registering specified ranks and attachment positions of the motion sensors in the position determination information in advance.

### APPLICATION EXAMPLE 5

This application example is directed to the motion analysis system described above, wherein the position determination information includes information corresponding to types of motions set as targets of a motion analysis.

In the motion analysis system, the position determination information includes the information corresponding to types of motions set as targets of a motion analysis. Consequently, it is possible to accurately determine attachment positions of the motion sensors on the basis of specified ranks and attachment positions in the position determination information adapted to the types of the motions.

### APPLICATION EXAMPLE 6

This application example is directed to the motion analysis system described above, wherein the position determination information includes information concerning the number of the plurality of motion sensors, and the attachment-position determining unit verifies the number of the motion sensors attached to the measurement target using the information concerning the number.

In the motion analysis system, the attachment-position determining unit verifies the number of the motion sensors attached to the measurement target on the basis of the information concerning the number in the position determination information. Consequently, it is possible to prevent necessary motion sensors from not being attached to the measurement target and prevent unnecessary motion sensors from being attached to the measurement target.

### APPLICATION EXAMPLE 7

This application example is directed to the motion analysis system described above, wherein the position determination information includes information indicating a proper range of measurement values represented by respective output signals of the plurality of motion sensors, and the attachment-position determining unit verifies measurement values represented by respective output signals of the plurality of motion sensors attached to the measurement target using the information indicating the proper range of the measurement values.

In the motion analysis system, the attachment-position determining unit verifies measurement values of the motion sensors attached to the measurement target on the basis of the information indicating the proper range of the measurement values in the position determination information. Consequently, it is possible to verify whether the motion sensors are adapted to regions to which the motion sensors are attached in the measurement target.

### APPLICATION EXAMPLE 8

This application example is directed to the motion analysis system described above, wherein the motion analysis system further includes: a determination-result output unit configured to output the attachment positions of the motion sensors to the measurement target determined by the attachment-position determining unit; and a receiving unit configured to receive a change of the attachment positions of the motion sensors to the measurement target.

In the motion analysis system, the determination-result output unit outputs the attachment positions of the motion sensors to the measurement target. The receiving unit receives a change of the attachment positions of the motion sensors to the measurement target. Consequently, a user can refer to the attachment positions of the motion sensors to the measurement target as candidates and, when the attachment positions are incorrect, correct the attachment positions via the receiving unit.

### APPLICATION EXAMPLE 9

This application example is directed to a motion analysis method including: comparing respective output signals of a plurality of motion sensors attached to a measurement target; and determining attachment positions of the motion sensors to the measurement target using a comparison result of the comparison of the output signals.

In the motion analysis method, respective output signals of the plurality of motion sensors attached to the measurement target are compared. Attachment positions of the motion sensors are determined on the basis of a comparison result of the comparison of the output signals. Since attachment positions of the motion sensors are determined on the basis of the output signals of the motion sensors, it is possible to automatically determine attachment positions of the motion sensors.

Consequently, labor and time for registration work concerning attachment positions of the motion sensors are unnecessary. Further, it is possible to prevent a trouble such as wrong registration of attachment positions of the motion sensors and accurately detect motions of regions of a person or an object.

### BRIEF DESCRIPTION OF THE DRAWINGS

The invention will be described with reference to the accompanying drawings, wherein like numbers reference like elements.

FIG. 1 is a block diagram showing the configuration of a motion analysis system.

FIG. 2 is a flowchart for explaining operations in a motion analysis apparatus.

FIG. 3 is an example of sensors attached to a measurement target of a golf swing.

FIG. 4 is a flowchart for explaining details of an operation for determining attachment positions of the sensors.

FIG. 5 is a diagram showing an example of position determination information related to the golf swing.

FIG. 6 is an example of angular velocity data involved in the golf swing detected by the sensors attached to a shaft and a forearm.

FIG. 7 is a flowchart for explaining operations in a motion analysis apparatus in a second embodiment.

FIG. 8 is an example of sensors attached to a measurement target of running.

FIG. 9 is a diagram showing an example of position determination information related to the running.

FIG. 10 is an example of angle data involved in the running detected by the sensors attached to a user.

### DESCRIPTION OF EXEMPLARY EMBODIMENTS

Preferred embodiments of the invention are explained in detail below. The embodiments explained below do not unduly limit contents of the invention described in the appended claims. Not all of components explained in the embodiments are essential as solving means of the invention.

### First Embodiment

A motion analysis system according to a first embodiment is explained with reference to the drawings.

### Configuration of the Motion Analysis System

First, the configuration of the motion analysis system is explained.

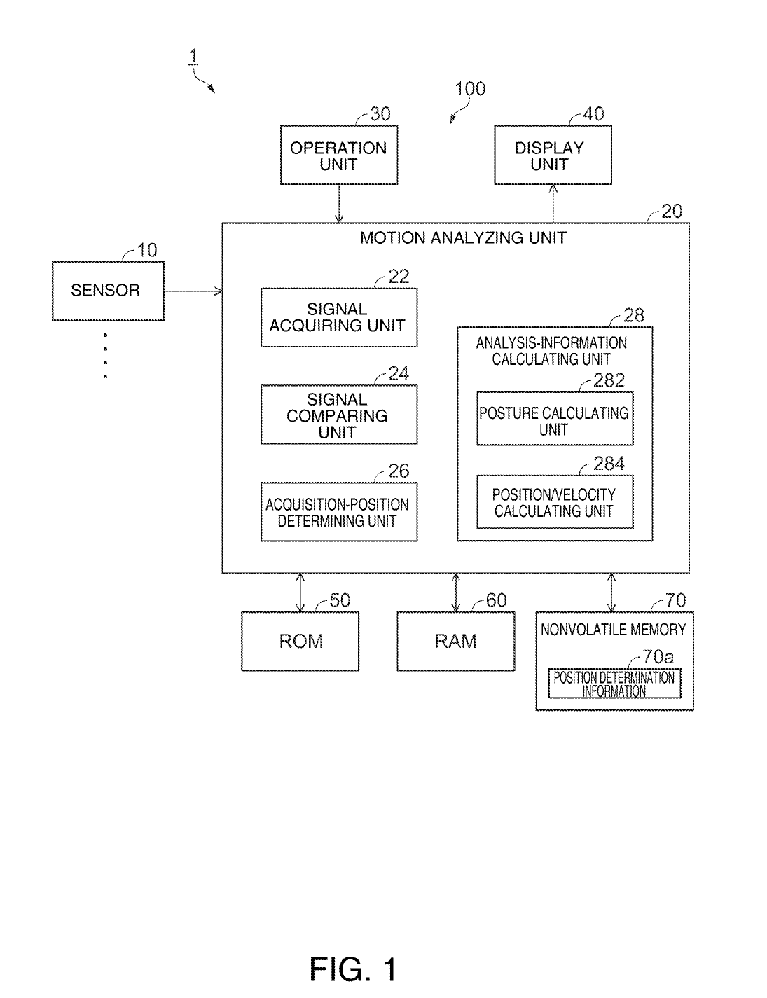

FIG. 1 is a block diagram showing the configuration of the motion analysis system according to this embodiment. A motion analysis system 1 in this embodiment includes a plurality of sensors 10 and a motion analysis apparatus 100 including a motion analyzing unit 20, an operation unit 30, a display unit 40, a ROM 50, a RAM 60, and a nonvolatile memory 70.

Each of the plurality of sensors 10 is a motion sensor that is attached to a measurement target, detects a movement of the measurement target, and outputs a signal. In this embodiment, the sensor 10 includes an angular velocity sensor (a gyro sensor) and an acceleration sensor. The angular velocity sensor detects an angular velocity around a detection axis and outputs an output signal corresponding to the magnitude of the detected angular velocity. In order to calculate a posture of the measurement target, the angular velocity sensor in this embodiment includes, for example, three angular velocity sensors that respectively detect angular velocities in directions of three axes (an x axis, a y axis, and a z axis).

The acceleration sensor detects acceleration in a detection axis direction and outputs an output signal corresponding to the magnitude of the detected acceleration. In order to calculate a position and a velocity of the measurement target, the acceleration sensor in this embodiment includes, for example, three acceleration sensors that respectively detect accelerations in directions of three axes (an x axis, a y axis, and a z axis).

The motion analysis apparatus 100 is, for example, a personal computer or a dedicated apparatus. The motion analysis apparatus 100 receives output signals from the sensors 10 and performs a motion analysis concerning a measurement target. The sensors 10 and the motion analysis apparatus 100 are connected by radio. However, connection of the sensors 10 and the motion analysis apparatus 100 is not limited to the radio connection. Wired connection may be used depending on types of objects to which the sensors 10 are attached.

The operation unit 30 performs processing for acquiring operation data from a user and sending the operation data to the motion analyzing unit 20. The operation unit 30 is, for example, a touch panel type display, buttons, keys, or a microphone.

The display unit 40 displays a processing result in the motion analyzing unit 20 as characters, a graph, or other images. The display unit 40 is, for example, a CRT, an LCD, a touch panel type display, or a HMD (head mounted display). For example, functions of both of the operation unit 30 and the display unit 40 may be realized by one touch panel type display.

The ROM 50 is a storing unit configured to store a computer program for performing various kinds of calculation processing and control processing in the motion analyzing unit 20 and various computer programs, data, and the like for realizing application functions.

The RAM 60 is a storing unit used as a work area of the motion analyzing unit 20 and configured to temporarily store, for example, computer programs and data read out from the ROM 50 or the like, data acquired in the operation unit 30, and results of calculations executed by the motion analyzing unit 20 according to various computer programs.

The nonvolatile memory 70 is a recording unit configured to record, for example, data referred to in processing by the motion analyzing unit 20 and data required to be stored for a long period among generated data. Position determination information 70a referred to by a signal comparing unit 24 and an attachment-position determining unit 26 (explained below) is stored in the nonvolatile memory 70.

The motion analyzing unit 20 includes a signal acquiring unit 22, a signal comparing unit 24, an attachment-position determining unit 26, and an analysis-information calculating unit 28. The motion analyzing unit 20 performs various kinds of processing according to the computer programs stored in the ROM 50. The motion analyzing unit 20 can be realized by a microprocessor such as a CPU.

The signal acquiring unit 22 performs processing for acquiring output signals from the sensors 10. The acquired signals are stored in, for example, the RAM 60.

The signal comparing unit 24 compares measurement values represented by the output signals from the sensors 10 and calculates comparative ranks obtained by ranking the measurement values. At this point, the signal comparing unit 24 refers to the position determination information 70a stored in the nonvolatile memory 70.

The attachment-position determining unit 26 determines attachment positions of the sensors 10 on the basis of the comparative ranks of the sensors 10, the measurement values of which are ranked by the signal comparing unit 24. At this point, the attachment-position determining unit 26 refers to the position determination information 70a stored in the nonvolatile memory 70.

The analysis-information calculating unit 28 includes a posture calculating unit 282 and a position/velocity calculating unit 284. The posture calculating unit 282 performs processing for calculating a posture of a measurement target using a measurement value of an angular velocity acquired from the sensor 10. The position/velocity calculating unit 284 performs processing for calculating a position and a velocity of the measurement target using a measurement value of acceleration acquired from the sensor 10.

### Operations of the Motion Analysis Apparatus

Operation contents in the motion analysis apparatus 100 are explained.

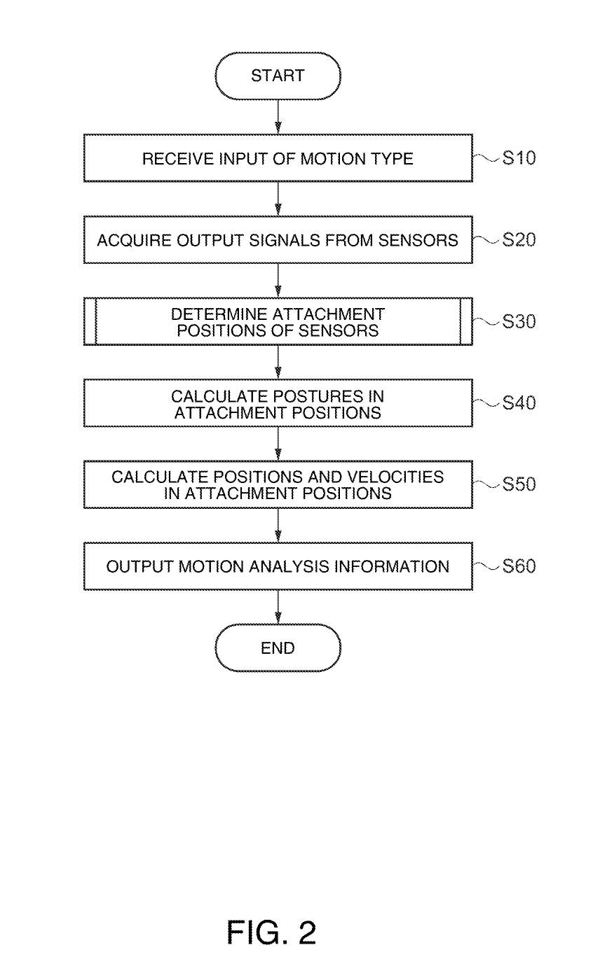

FIG. 2 is a flowchart for explaining operations in the motion analysis apparatus 100. The operations in the motion analysis apparatus 100 are performed by the motion analyzing unit 20 executing processing according to various computer programs.

First, the motion analyzing unit 20 receives, with the operation unit 30, a motion typeset as a target of a motion analysis from the user (step S10).

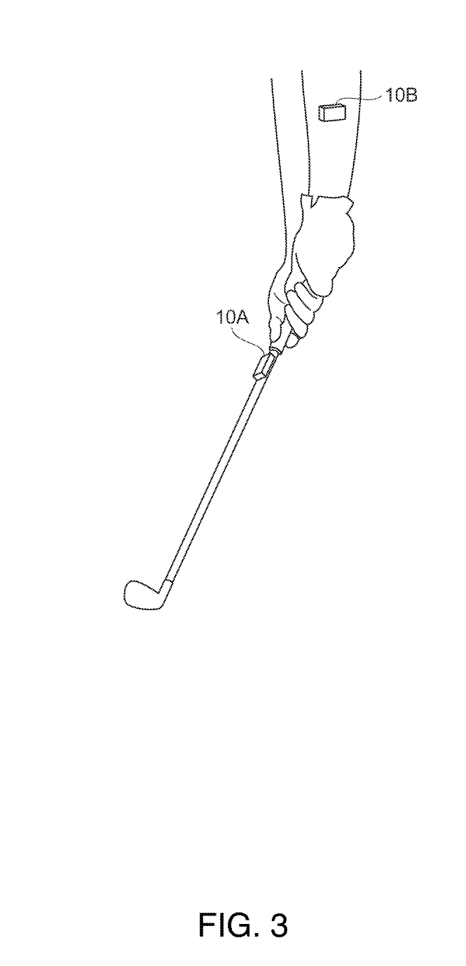

In this embodiment, it is assumed that the user selects a motion analysis related to a golf swing as a motion type via the operation unit 30. FIG. 3 shows an example of the sensors 10 attached to a measurement target of a golf swing. In FIG. 3, two sensors 10A and 10B are attached to a measurement target. The sensor 10A is attached to a position close to a grip in a shaft of a golf club. On the other hand, the sensor 10B is attached to the forearm of the user.

The number of the sensors 10 attached to the measurement target is not limited to two and may be three or more. Attachment positions of the sensors 10 attached to the measurement target are not limited to the example shown in FIG. 3. The sensors 10 may be attached to arbitrary places.

Subsequently, the motion analyzing unit 20 acquires, with the signal acquiring unit 22, output signals from the sensors 10 attached to the measurement target (step S20).

In this embodiment, in a state in which the sensors 10A and 10B are attached, the user grips the golf club and performs a swing action. During the swing action, the signal acquiring unit 22 acquires an output signal from the sensor 10A involved in the movement of the shaft of the golf club and an output signal from the sensor 10B involved in the motion of the forearm of the user.

Subsequently, the motion analyzing unit 20 determines, with the attachment-position determining unit 26, attachment positions of the sensors 10 attached to the measurement target (step S30).

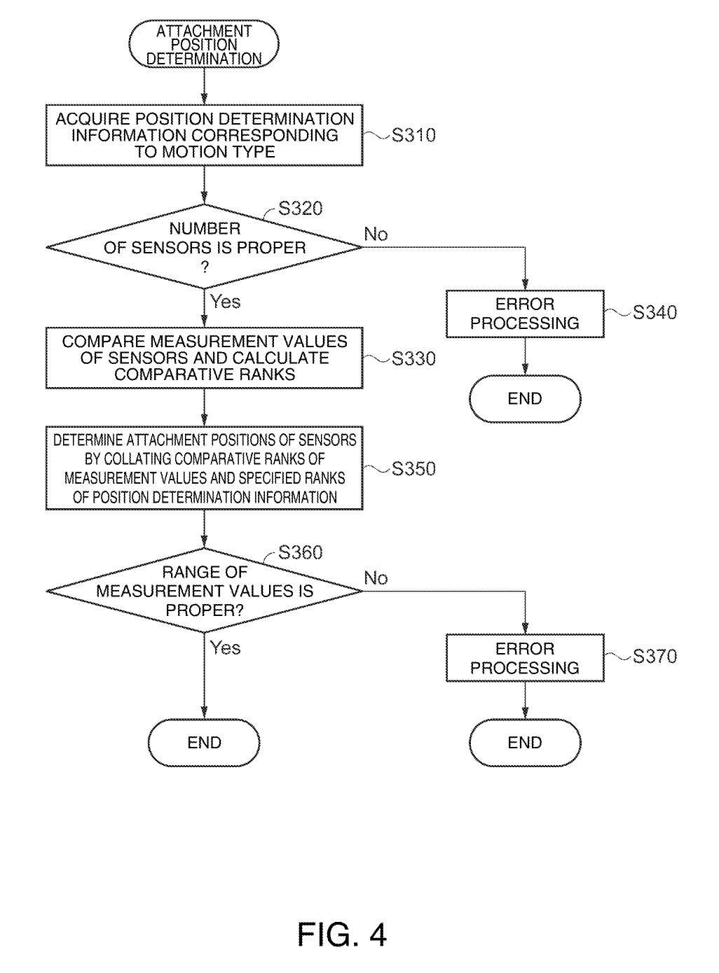

FIG. 4 is a flowchart for explaining details of an operation for determining attachment positions of the sensors 10. In the flowchart of FIG. 4, first, the motion analyzing unit 20 acquires, from the nonvolatile memory 70 (see FIG. 1), the position determination information 70a corresponding to the motion type received from the user in step S10 (see FIG. 2).

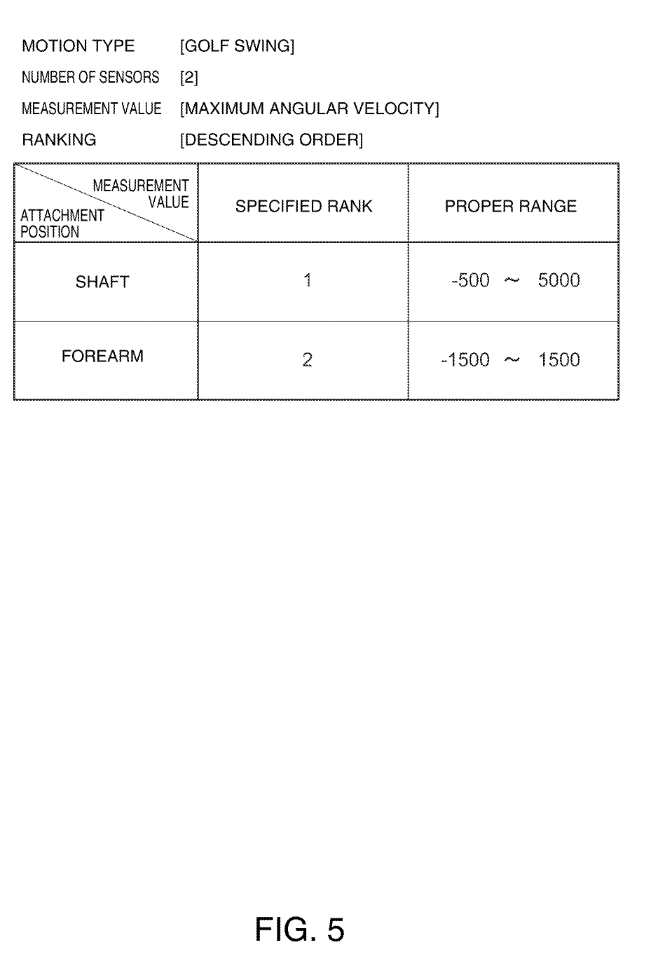

FIG. 5 is a diagram showing an example of the position determination information 70a related to the golf swing. FIG. 5 indicates that the position determination information 70a is the position determination information 70a of a motion type “golf swing”. The position determination information 70a indicates that the number of sensors attached to the measurement target is “2” and attachment positions of the sensors are determined by ranking measurement values “maximum angular velocities” in “descending order”. A table in FIG. 5 indicates a relation between the attachment positions of the sensors and specified ranks obtained by ranking the magnitude of the measurement values. For example, the maximum angular velocity of the sensor attached to the “shaft” has the specified rank “1” and is larger than the maximum angular velocity (the specified rank “2”) of the sensor attached to the “forearm”. In this way, the specified ranks are given in the descending order of the maximum angular velocities. A proper range of the maximum angular velocity of the sensor attached to the “shaft” is “−500 to 5000” dps.

Subsequently, the motion analyzing unit 20 determines, on the basis of the position determination information 70a acquired in step S310, whether the number of the sensors 10 actually attached to the measurement target is proper (step S320).

In this embodiment, the motion analyzing unit 20 acquires output signals from the two sensors 10A and 10B in step S20 (see FIG. 2). The motion analyzing unit 20 determines whether the number of the sensors 10 and the number of sensors “2” in FIG. 5 coincide with each other. For example, when only one sensor 10 is attached or three or more sensors 10 are attached, the motion analyzing unit 20 determines that the number of the sensors 10 is improper.

When the number of the sensors 10 is proper (Yes in step S320), the motion analyzing unit 20 proceeds to the next step S330.

On the other hand, when the number of the sensors 10 is improper (No in step S320), the motion analyzing unit 20 proceeds to step S340, displays an error message such as “the number of attached sensors is incorrect” on the display unit 40 (see FIG. 1), and ends the processing of the flowchart of FIG. 2. Consequently, it is possible to prevent such a trouble that a necessary number of the sensors 10 are not attached to the measurement target or, conversely, an unnecessary number of the sensors 10 larger than the necessary number are attached to the measurement target.

In step S330, the motion analyzing unit 20 compares, with the signal comparing unit 24, measurement values of the sensors 10 attached to the measurement target and calculates comparative ranks by ranking the magnitudes of the measurement values.

In this embodiment, first, the motion analyzing unit 20 calculates maximum angular velocities in the sensors 10 concerning the output signals from the sensors 10 acquired in step S20 (see FIG. 2). Subsequently, the motion analyzing unit 20 compares the maximum angular velocities in the sensors 10 and calculates comparative ranks by ranking the maximum angular velocities in descending order.

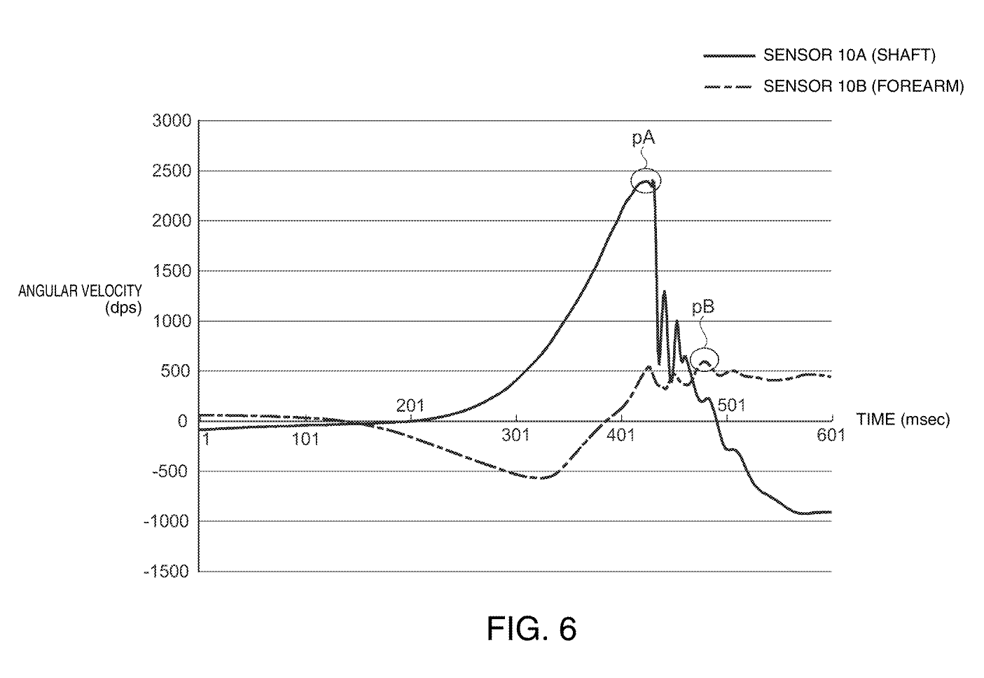

FIG. 6 shows an example of angular velocity data around the Y axis involved in the golf swing detected by the sensors 10 attached to the shaft and the forearm. In FIG. 6, a graph indicated by a solid line indicates a relation between an elapsed time and an angular velocity concerning the sensor 10A attached to the shaft. As shown in FIG. 6, a maximum angular velocity of the sensor 10A attached to the shaft is an angular velocity pA indicated by encircling. The part of the angular velocity pA indicates timing of impact in the golf swing. On the other hand, in FIG. 6, a graph indicated by an alternate long and short dash line indicates a relation between an elapsed time and an angular velocity concerning the sensor 10B attached to the forearm. As shown in FIG. 6, a maximum angular velocity of the sensor 10B attached to the forearm is an angular velocity pB indicated by encircling. The angular velocity pB indicates timing immediately after the impact in the golf swing.

As shown in FIG. 6, the angular velocity pA in the sensor 10A is clearly larger than the angular velocity pB in the sensor 10B. Therefore, the comparative ranks of the maximum angular velocities in step S330 are calculated as “1” for the sensor 10A and “2” for the sensor 10B.

Subsequently, the motion analyzing unit 20 determines, with the attachment-position determining unit 26, attachment positions of the sensors 10 by collating the comparative ranks of the sensors 10 ranked in step S330 and the specified ranks of the position determination information 70a acquired in step S310 (step S350).

In this embodiment, the motion analyzing unit 20 determines attachment positions of the sensors 10 by collating the comparative ranks of the maximum angular velocities in the sensors 10 and the specified ranks of the attachment positions in FIG. 5. As explained above, the comparative ranks of the maximum angular velocities are “1” for the sensor 10A and “2” for the sensor 10B. Therefore, the motion analyzing unit 20 can determine that the sensor 10A is attached to the “shaft” and the sensor 10B is attached to the “forearm”.

Subsequently, the motion analyzing unit 20 determines, concerning the sensors 10, the attachment positions of which are determined in step S350, whether a range of measurement values is proper (step S360).

In this embodiment, the motion analyzing unit 20 determines whether the angular velocity pA (see FIG. 6) of the sensor 10A, the attachment position of which is determined as the “shaft” in FIG. 5, is in a proper range “−500 to 5000” dps shown in FIG. 5. The motion analyzing unit 20 determines whether the angular velocity pB (see FIG. 6) of the sensor 10B, the attachment position of which is determined as the “forearm” in FIG. 5, is in a proper range “−1500 to 1500” dps shown in FIG. 5.

When the ranges of the measurement values are proper concerning all the sensors 10 (Yes in step S360), the motion analyzing unit 20 returns to the flowchart of FIG. 2.

On the other hand, when a range of a measurement value of at least one of the sensors 10 is improper (No in step S360), the motion analyzing unit 20 proceeds to step S370, displays an error message such as “the sensor XX is not attached to the correct position” on the display unit 40, and ends the processing of the flowchart of FIG. 2. Consequently, it is possible to prevent such a trouble that the sensors 10 are attached to regions that are not analysis targets in a measurement target or the sensors 10 are redundantly attached to analysis target regions.

Referring back to FIG. 2, in step S40, the motion analyzing unit 20 calculates, with the posture calculating unit 282 of the analysis-information calculating unit 28, postures in the attachment positions on the basis of angular velocity data included in the output signals from the sensors 10 acquired in step S20.

In this embodiment, the motion analyzing unit 20 calculates a posture of the shaft of the golf club on the basis of the angular velocity data from the sensor 10A. The motion analyzing unit 20 calculates a posture of the forearm of the user, who grips the golf club, on the basis of the angular velocity data from the sensor 10B.

Subsequently, the motion analyzing unit 20 calculates, with the position/velocity calculating unit 284 of the analysis-information calculating unit 28, positions and velocities in the attachment positions on the basis of acceleration data included in the output signals from the sensors 10 acquired in step S20 (step S50). For example, the position/velocity calculating unit 284 can calculate a direction of gravitational acceleration from the postures in the attachment positions calculated in step S40, cancel the gravitational acceleration from the acceleration data and integrate the acceleration data to calculate a velocity, and further integrate the velocity to calculate a position.

In this embodiment, the motion analyzing unit 20 calculates a position and a velocity of the shaft of the golf club on the basis of the acceleration data from the sensor 10A. The motion analyzing unit 20 calculates a position and a velocity of the forearm of the user, who grips the golf club, on the basis of the acceleration data from the sensor 10B.

Subsequently, the motion analyzing unit 20 displays, on the display unit 40, motion analysis information concerning the golf swing of the user on the basis of information concerning the postures, the positions, and the velocities in the attachment positions calculated in steps S40 and S50 (step S60) and ends the processing of the flowchart of FIG. 2.

In the embodiment explained above, the motion analyzing unit 20 compares measurement values of the sensors 10 attached to the measurement target and calculates comparative ranks concerning the sensors 10. Then, the motion analyzing unit 20 collates the comparative ranks calculated from the measurement values of the sensors 10 with the specified ranks of the position determination information 70a to thereby determine attachment positions of the sensors 10. In this way, the attachment positions of the sensors 10 are automatically determined on the basis of the measurement values of the sensors 10. Therefore, the user does not need to manually register attachment positions of the sensors 10 and can efficiently and accurately perform a motion analysis in a short time concerning the measurement target.

### Second Embodiment

A motion analysis system according to a second embodiment is explained below with reference to the drawings.

The motion analysis system according to the second embodiment has a configuration substantially the same as the configuration of the motion analysis system 1 according to first embodiment. However, the motion analysis system according to the second embodiment is different from the motion analysis system according to the first embodiment in operation contents in the motion analysis apparatus 100.

### Operations of the Motion Analysis Apparatus

Operation contents in the motion analysis apparatus 100 in this embodiment are explained.

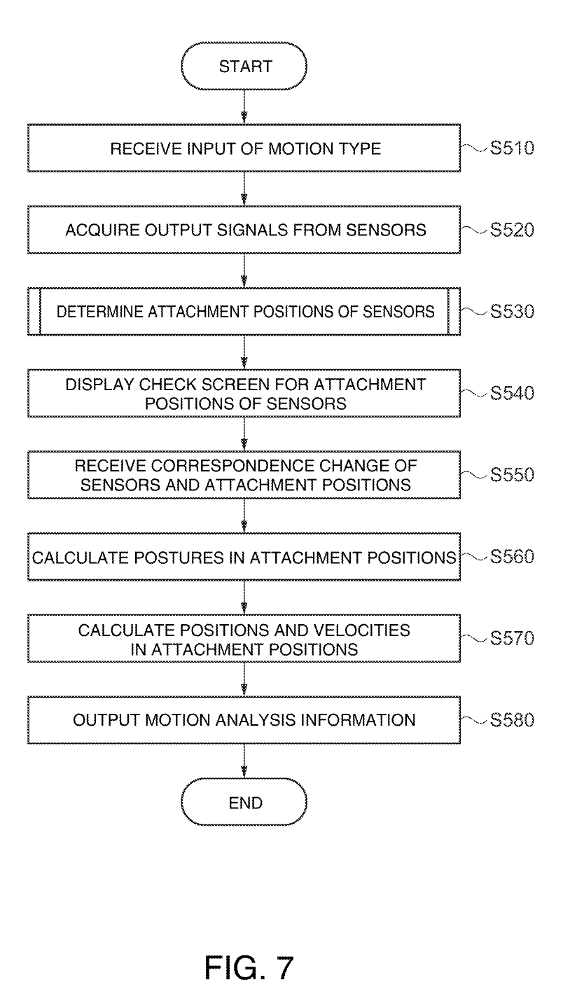

FIG. 7 is a flowchart for explaining operations in the motion analysis apparatus 100 in this embodiment.

First, the motion analyzing unit 20 receives, with the operation unit 30, a motion type set as a target of a motion analysis from a user (step S510).

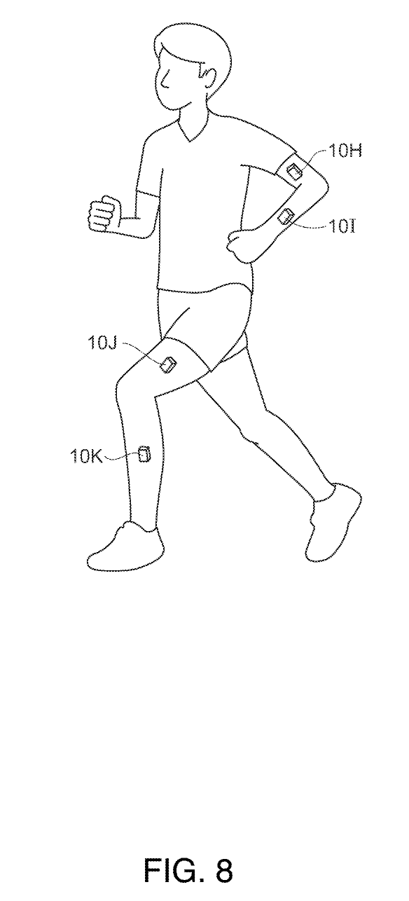

In this embodiment, it is assumed that the user selects a motion analysis related to running as a motion type via the operation unit 30. FIG. 8 shows an example of the sensors 10 attached to a measurement target of running. In FIG. 8, four sensors 10H, 10I, 10J, and 10K are attached to the measurement target. The sensors 10H, 10I, 10J, and 10K are respectively attached to the upper arm, the forearm, the thigh, and the lower leg of the user who does running.

Subsequently, the motion analyzing unit 20 acquires, with the signal acquiring unit 22, output signals from the sensors 10 attached to the measurement target (step S520).

In this embodiment, the user runs in a state in which the sensors 10H, 10I, 10J, and 10K are attached. During the running, the signal acquiring unit 22 acquires output signals from the sensors 10H, 10I, 10J, and 10K involved in respective motions of the upper arm, the forearm, the thigh, and the lower leg of the user.

Subsequently, the motion analyzing unit 20 determines, with the attachment-position determining unit 26, attachment positions of the sensors 10 attached to the measurement target (step S530).

Concerning an operation for determining attachment positions of the sensors 10, the flowchart in the first embodiment shown in FIG. 4 can be directly applied.

In the flowchart of FIG. 4, first, the motion analyzing unit 20 acquires, from the nonvolatile memory 70, the position determination information 70a corresponding to the motion type received from the user in step S510 (see FIG. 7) (step S310).

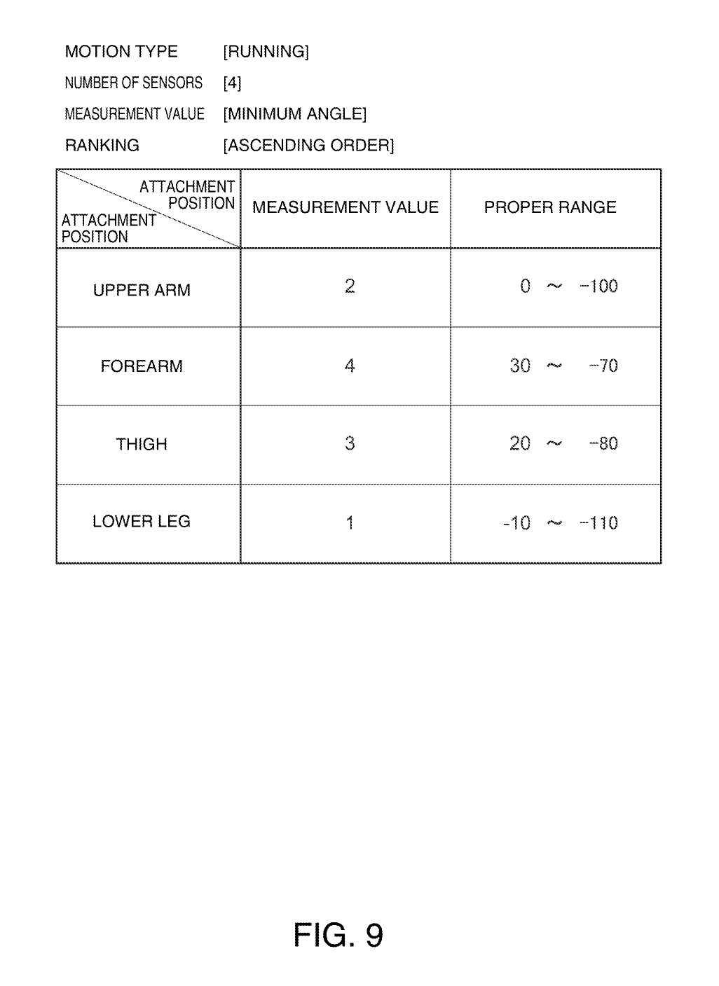

FIG. 9 is a diagram showing an example of the position determination information 70a related to the running. FIG. 9 indicates that the position determination information 70a is the position determination information 70a of a motion type “running”. The position determination information 70a indicates that the number of sensors attached to the measurement target is “4” and attachment positions of the sensors are determined by ranking measurement values “minimum angles” in “ascending order”. Angles of measurement values can be calculated from, for example, an integration result of the angular velocity sensor. A table in FIG. 9 indicates a relation between the attachment positions of the sensors and specified ranks that specify the magnitudes of the measurement values. For example, a specified rank of the minimum angle of the sensor attached to the “lower leg” is “1”. The sensor has the smallest minimum angle compared with the sensors in the other attachment positions. In this way, the specified ranks are given in the ascending order of the minimum angles. A proper range of the minimum angle of the sensor attached to the “lower leg” is “−10 to 110”°.

Subsequently, the motion analyzing unit 20 determines, on the basis of the position determination information 70a acquired in step S310, whether the number of the sensors 10 actually attached to the measurement target is proper (step S320).

In this embodiment, the motion analyzing unit 20 acquires output signals from the four sensors 10H, 10I, 10J, and 10K in step S520 (see FIG. 7). The motion analyzing unit 20 determines whether the number of the sensors 10 and the number of sensors “4” in FIG. 9 coincide with each other.

When the number of the sensors 10 is proper (Yes in step S320), the motion analyzing unit 20 proceeds to the next step S330.

On the other hand, when the number of the sensors 10 is improper (No in step S320), the motion analyzing unit 20 proceeds to step S340, displays an error message on the display unit 40, and ends the processing of the flowchart of FIG. 7.

In step S330, the motion analyzing unit 20 compares, with the signal comparing unit 24, measurement values of the sensors 10 attached to the measurement target and calculates comparative ranks by ranking the magnitudes of the measurement values.

In this embodiment, first, the motion analyzing unit 20 calculates minimum angles in the sensors 10 concerning the output signals from the sensors 10 acquired in step S520 (see FIG. 7). Subsequently, the motion analyzing unit 20 compares the minimum angles in the sensors 10 and calculates comparative ranks by ranking the minimum angles in ascending order.

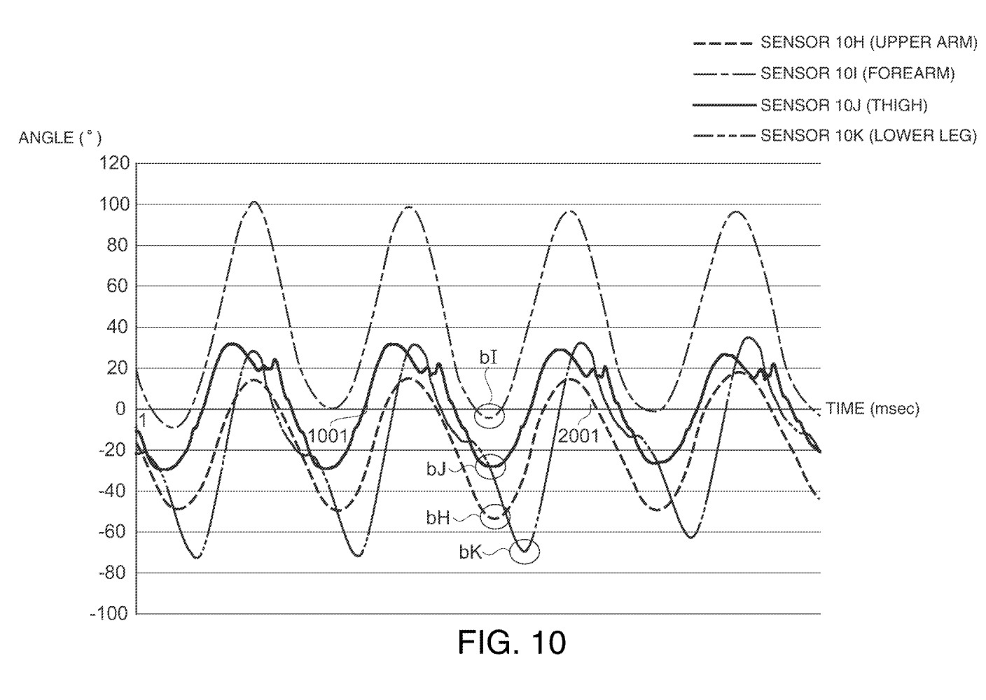

FIG. 10 shows an example of angle data involved in the running detected by the sensors 10 attached to the user. In FIG. 10, graphs indicated by a broken line, an alternate long and short dash line, a solid line, and an alternate long and two short dashes line respectively indicate relations between elapsed times and angles concerning the sensor 10H attached to the upper arm, the sensor 10I attached to the forearm, the sensor 10J attached to the thigh, and the sensor 10K attached to the lower leg. In the graphs shown in FIG. 10, angles detected by the sensors 10 increase and decrease in synchronization with arm swings and running steps involved in the running. As shown in FIG. 10, respective minimum angles of the sensor 10H in the upper arm, the sensor 10I in the forearm, the sensor 10J in the thigh, and the sensor 10K in the lower leg are an angle bH, an angle bI, an angle bJ, and an angle bK indicated by encircling.

As shown in FIG. 10, the minimum angles in the sensors 10 are the angle bK of the sensor 10K, the angle bH of the sensor 10H, the angle bJ of the sensor 10J, and the angle bI of the sensor 10I in ascending order. Therefore, the comparative ranks of the minimum angles in step S330 are calculated as “1” for the sensor 10K, “2” for the sensor 10H, “3” for the sensor 10J, and “4” for the sensor 10I.

Subsequently, the motion analyzing unit 20 determines, with the attachment-position determining unit 26, attachment positions of the sensors 10 by collating the comparative ranks of the sensors 10 ranked in step S330 and the specified ranks of the position determination information 70a acquired in step S310 (step S350).

In this embodiment, the motion analyzing unit 20 determines attachment positions of the sensors 10 by collating the comparative ranks of the minimum angles in the sensors 10 and the specified ranks of the attachment positions in FIG. 9. As explained above, the comparative ranks of the minimum angles are “1” for the sensor 10K, “2” for the sensor 10H, “3” for the sensor 10J, and “4” for the sensor 10I. Therefore, the motion analyzing unit 20 can determine that the sensor 10K is attached to the “lower leg”, the sensor 10H is attached to the “upper arm”, the sensor 10J is attached to the “thigh”, and the sensor 10I is attached to the “forearm”.

Subsequently, the motion analyzing unit 20 determines, concerning the sensors 10, the attachment positions of which are determined in step S350, whether a range of measurement values is proper (step S360).

In this embodiment, the motion analyzing unit 20 determines whether the angle bH, the angle bI, the angle bJ, and the angle bK of the sensor 10H, the sensor 10I, the sensor 10J, and the sensor 10K, the attachment positions of which are respectively determined as the “upper arm”, the “forearm”, the “thigh”, and the “lower leg”, are respectively in proper ranges “0 to −100”°, “30 to −70”°, “20 to −80”°, and “−10 to −110”° shown in FIG. 9.

When the ranges of the measurement values are proper concerning all the sensors 10 (Yes in step S360), the motion analyzing unit 20 returns to the flowchart of FIG. 7.

On the other hand, when a range of a measurement value of at least one of the sensors 10 is improper (No in step S360), the motion analyzing unit 20 proceeds to step S370, displays an error message on the display unit 40, and ends the processing of the flowchart of FIG. 7.

Referring back to FIG. 7, in step S540, the motion analyzing unit 20 displays, on the display unit 40 functioning as the determination-result output unit, a confirmation screen for the attachment positions of the sensors 10 determined in step S350 (see FIG. 4).

In this embodiment, the motion analyzing unit 20 displays, on the display unit 40, for example, a correspondence table indicating that the sensor 10H is attached to the “upper arm”, the sensor 10I is attached to the “forearm”, the sensor 10J is attached to the “thigh”, and the sensor 10K is attached to the “lower leg”.

Subsequently, when there is a change to the check screen for the attachment positions displayed in step S540, the motion analyzing unit 20 receives, with the operation unit 30 functioning as the receiving unit, the change from the user (step S550).

Subsequently, the motion analyzing unit 20 calculates, with the posture calculating unit 282 of the analysis-information calculating unit 28, postures in the attachment positions after the reception of the change in step S550 on the basis of angle data included in the output signals from the sensors 10 acquired in step S520 (step S560).

In this embodiment, the motion analyzing unit 20 calculates postures involved in the running concerning the upper arm, the forearm, the thigh, and the lower leg of the user to which the sensors 10H, 10I, 10J, and 10K are respectively attached.

Subsequently, the motion analyzing unit 20 calculates, with the position/velocity calculating unit 284 of the analysis-information calculating unit 28, positions and velocities in the attachment positions after the reception of the change in step S550 on the basis of acceleration data included in the output signals from the sensors 10 acquired in step S520 (step S570).

In this embodiment, the motion analyzing unit 20 calculates positions and velocities involved in the running concerning the upper arm, the forearm, the thigh, and the lower leg of the user to which the sensors 10H, 10I, 10J, and 10K are respectively attached.

Subsequently, the motion analyzing unit 20 displays, on the display unit 40, motion analysis information concerning the running of the user on the basis of information concerning the postures, the positions, and the velocities in the attachment positions calculated in steps S560 and S570 (step S580) and ends the processing of the flowchart of FIG. 7.

In the embodiment explained above, after determining the attachment positions of the sensors 10, the motion analyzing unit 20 displays the check screen for the attachment positions on the display unit 40. When there is a change to the check screen, the motion analyzing unit 20 receives the change from the user. When a large number of sensors 10 are attached to the user who does running as in this embodiment, for example, depending on physical characteristics, a running form, or the like of the user, it is likely that the position determination information 70a of a fixed form cannot be directly applied. In such a case, it is possible to display automatically determined attachment positions of the sensors 10 on a screen as candidates and receive correction of the attachment position. Consequently, it is possible to properly apply the motion analysis system according to actual situations of various motion types and motion environments.

### Modification 1

In the embodiments explained above, in the state in which the sensors 10 are attached to the measurement target, the user performs a motion of, for example, gripping the golf club and performing the swing action. After the motion ends, the sensors 10 and the measurement target are associated with each other. However, the association of the sensors 10 and the measurement target may be performed before the user starts the motion rather than after the motion set as a target of an analysis ends. For example, before the user starts the motion, the user may be asked to perform a specified movement with respect to the measurement target to which the sensors 10 are attached. The association of the sensors 10 and the measurement target may be performed on the basis of the movement.

### Modification 2

In the embodiments explained above, attachment positions of the sensors 10 are determined by comparing the maximum angular velocities or the minimum angles detected by the angular velocity sensors included in the sensors 10. However, according to a motion type, attachment positions of the sensors 10 may be determined by comparing minimum angular velocities, maximum angles, or the like detected by the angular velocity sensors. Attachment positions of the sensors 10 may be determined by comparing maximum accelerations or minimum accelerations detected by the acceleration sensors included in the sensors 10. In another form, for example, combinations of accelerations and angular velocities may be compared to perform a comparison by angular velocities at points when maximum accelerations are generated. Angular velocities (change ratios of angular velocities) calculated from angular velocities or jerks (change ratios of accelerations) calculated from accelerations may be used. The comparison is not limited to the maximums or minimums of the measurement values of the sensors 10. Attachment positions of the sensors 10 may be determined by comparing averages, modes, medians, singular values, waveform patterns, or the like. Further, sensors included in the sensors 10 are not limited to inertial sensors such as the angular velocity sensors and the acceleration sensors. Attachment positions of the sensors 10 may be determined on the basis of measurement values of arbitrary sensors such as pressure sensors, optical sensors, magnetic sensors, or temperature sensors.

The entire disclosure of Japanese Patent Application No. 2012-266039, filed Dec. 5, 2012 is expressly incorporated by reference herein.

What is claimed is:

1. A motion analysis system comprising:
a signal comparing unit configured to compare output signals from a plurality of motion sensors attached to a measurement target; and
an attachment-position determining unit configured to determine attachment positions of the motion sensors to the measurement target using a comparison result of the signal comparing unit.

2. The motion analysis system according to claim 1, wherein the signal comparing unit compares at least one of maximums or minimums concerning at least one of angular velocities and angles represented by the respective output signals of the plurality of motion sensors.

3. The motion analysis system according to claim 1, wherein the signal comparing unit compares at least one of maximums or minimums concerning accelerations represented by the respective output signals of the plurality of motion sensors.

4. The motion analysis system according to claim 1, wherein
the motion analysis system includes position determination information used for determining attachment positions of the motion sensors,
the position determination information includes information concerning specified ranks respectively specified concerning the plurality of motion sensors and attachment positions corresponding to the specified ranks, and
the attachment-position determining unit determines attachment positions by collating respective comparative ranks of the plurality of motion sensors and the specified ranks included in the position determination information using a comparison result of the signal comparing unit.

5. The motion analysis system according to claim 4, wherein the position determination information includes information corresponding to types of motions set as targets of a motion analysis.

6. The motion analysis system according to claim 4, wherein
the position determination information includes information concerning a number of the plurality of motion sensors, and
the attachment-position determining unit verifies a number of the motion sensors attached to the measurement target using the information concerning the number.

7. The motion analysis system according to claim 4, wherein
the position determination information includes information indicating a proper range of measurement values represented by respective output signals of the plurality of motion sensors, and
the attachment-position determining unit verifies measurement values represented by respective output signals of the plurality of motion sensors attached to the measurement target using the information indicating the proper range of the measurement values.

8. The motion analysis system according to claim 1, further comprising:
a determination-result output unit configured to output the attachment positions of the motion sensors to the measurement target determined by the attachment-position determining unit; and
a receiving unit configured to receive a change of the attachment positions of the motion sensors to the measurement target.

9. A motion analysis method comprising:
comparing respective output signals of a plurality of motion sensors attached to a measurement target; and
determining attachment positions of the motion sensors to the measurement target using a comparison result of the comparison of the output signals.
